(19) United States
(12) Patent Application Publication
(10) Pub. No.: US 2020/0120493 A1
(43) Pub. Date: Apr. 16, 2020

(54) APPARATUS AND METHOD FOR COMMUNICATIONS

(71) Applicant: Huawei Technologies Co., Ltd., Shenzhen (CN)

(72) Inventors: Ohad KLAUSNER, Hod Hasharon (IL); Avi WEITZMAN, Hod Hasharon (IL); Shimon SHILO, Hod Hasharon (IL); Doron EZRI, Hod Hasharon (IL)

(21) Appl. No.: 16/716,209

(22) Filed: Dec. 16, 2019

Related U.S. Application Data
(63) Continuation of application No. PCT/EP2017/064536, filed on Jun. 14, 2017.

(51) Int. Cl. H04W 12/00; H04W 52/02; H04L 1/16; H04W 12/04

(52) U.S. Cl. CPC H04W 12/0017; H04W 52/0222; H04W 84/12; H04W 12/00512; H04W 12/0401; H04L 1/1621

(57) ABSTRACT

The present invention proposes apparatus and method for transmissions.

### CROSS-REFERENCE TO RELATED APPLICATIONS

This application is a continuation of International Application No. PCT/EP2017/064536, filed on Jun. 14, 2017, the disclosure of which is hereby incorporated by reference in its entirety.

### TECHNICAL FIELD

The present invention relates to an apparatus, a method for communications and a computer program product.

### BACKGROUND

IEEE 802.11 based Wireless Local Area Networks (WLANs) became popular at an unprecedented rate. Besides traditional Internet connectivity for PC and laptop devices, the majority of WLAN network devices are mobile devices such as smart phones and so on. In the near future, the number of WLAN devices will be dramatically increased due to the emerging Internet of Things (IoT) devices market. However, most of the IEEE802.11 power save mechanisms are not optimized for small size devices with limited battery (e.g., IoT, mobile devices, etc.) and restrict power consumption requirements.

As shown in FIG. 1 and FIG. 2, a communication system 100 adopts a Wake-Up Radio (WUR) functionality in order to reduce power consumption of a mobile device. The communication system 100 includes an access point (AP) 102 and a mobile device 104. The mobile device 104 includes a primary radio 105 and a low power consumption receiver used as a WUR 107. According to a WUR concept, the primary radio 105 is used for data exchange including transmission and reception, and can switch between statuses “on” and “off” based on a trigger from the WUR 107. The WUR 107 is used to wake up the primary radio 105 but not used for data exchange. In FIG. 1, there is no data exchange between the AP 102 and the mobile device 104. The primary radio 105 is “off” and the WUR 107 is “on”. In FIG. 2, there is data to be exchanged between the AP 102 and the mobile device 104. A wake-up signal is transmitted from the AP 102 to the mobile device 104. Upon receiving the wake-up signal, the WUR 107 triggers the primary radio 105. The primary radio 105 turns to the status “on” and is ready for data exchange. The WUR 107 turns to the status “off”, for example because of an on/off duty-cycle of the WUR 10. Thereby, lower power consumption is achieved.

FIG. 3 shows a wake-up procedure for a power-saving device, for example the mobile device 104 as shown in FIG. 1 and FIG. 2. As shown in FIG. 3, to wake up the mobile device 104, the AP 102 sends a wake-up packet carrying an identifier (ID) of the mobile device 104 (to be woken up). The WUR 107 of the mobile device 104 receives the wake-up packet and wakes up the primary radio 105 of the mobile device 104, that is, turn it to be active. After turning to be active, the mobile device 104 sends a wake-up acknowledgement (e.g. PS-Poll) on its primary radio 105 to the AP 102 to solicit the AP's buffer unit. Then data packets are transmitted between the AP 102 and the mobile device 104. The mobile device sends an acknowledgment for data packet reception, which is namely Block ACK (BA). The “timeout” shown in FIG. 3 is a time unit. A countdown starts when a wake-up packet is sent, and if it expires (e.g., 0 is achieved) before the AP 102 receives the wake-up acknowledgment, the AP 102 sends again a wake-up packet to the same destination, i.e., the mobile device 104.

In the state of the art, malicious attacks on a WUR (e.g. the WUR 107 as shown in FIG. 1 and FIG. 2) can cause the WUR to falsely wake up the primary radio (e.g. the primary radio 105 as shown in FIG. 1 and FIG. 2). For example, when the attacker learns which wake-up packet is used to wake up which specific IoT device by capturing a MAC header of the wake-up acknowledgement (e.g. PS-Poll), it can use this information in order to repeat wakening up the IoT device until its battery drains out. The IoT device usually works on a button battery, which is only sufficient for a limited number of transmissions. Therefore, although a single attack may do little harm, frequently repeating such attacks can quickly drain the battery and ultimately disable the whole IoT device. Thus such an attack is also called a DoS (Denial of Service) attack. Furthermore, the attacker can masquerade as the IoT device when its battery has drained out and cause additional damages.

### SUMMARY

An object of the present invention is to provide an apparatus and a method for transmitting a wake-up signal in a more secure way, e.g. such that DoS attacks on communications of the wake-up signal can be mitigated.

The above-mentioned object of the present invention is achieved by the solution provided in the independent claims. Further, implementation forms are defined in the dependent claims.

In a first aspect of the present invention, a communication device (400) includes a transceiver (401) and a processor (403). The transceiver (401) is configured to receive from a second device (500) a wake-up signal for waking up the communication device (400). The processor (403) is configured to turn to active when the wake-up signal is received by the transceiver (401) and to perform a protection on an identifier (ID) of the communication device to obtain a protected identifier (pID) of the communication device. The transceiver (401) is further configured to transmit to the second device (500) a wake-up acknowledgement indicating that the communication device (400) is active, wherein the wake-up acknowledgement comprises the pID.

The protection of identifications in a wake-up acknowledgement makes it difficult for attackers to know an existence of the communication device 400 and the identifier(s) of the communication device 400. Therefore, e.g. vulnerability of the communication system to (battery-targeted) DoS attacks can be mitigated.

In a further implementation form of the first aspect of the present invention, the processor (403) is configured to perform the protection by scrambling and/or by encrypting the ID.

The scrambling or encryption of the ID can help safely prevent the ID from being detected by attackers and therefore the robust of the transmission is enhanced.

In a further implementation form of the first aspect of the present invention, the protection is based on random information.

The random information ensures that the pID outputs are different on each run, which makes more difficult for attackers to detect the ID and therefore the robust of the transmission is further enhanced.

In a further implementation form of the first aspect of the present invention, the processor (403) is configured to generate a randomized identifier (rID) of the communication device (400) based on the ID and the random information, and to perform the protection based on a key and the rID.

The ID is firstly randomized and then protected with a key. This can be easily accomplished by the processor and therefore the processing complexity of the communication device is limited.

In a further implementation form of the first aspect of the present invention, the random information is one of follows: an output of a cyclic counter, an output of a pseudorandom noise generator, and a payload of the wake-up acknowledgement.

Various options can be adopted by the processor to obtain the random information. This makes it easy for the processor to select one option according to practice requirement. Once an option is selected, the processor can obtain different random information each time, which enhances the robust of the transmission and improves the performance of the communication device.

In a further implementation form of the first aspect of the present invention, the transceiver (401) is further configured to exchange the random information and/or the key with the second device (500).

Exchanging at least one of the random information and the key with the receiving party of the wake-up acknowledgement can ensure a synchronization of information used by both communication parties of the wake-up acknowledgement. Therefore, the wake-up acknowledgement carrying the ID can be prepared by a correct transmitter and then safely parsed by a correct receiver. The whole process cannot by attacked by attackers.

In a further implementation form of the first aspect of the present invention, the ID includes an association identifier of the communication device and/or a Media Access Control, MAC, source address of the communication device.

One or more identifier can be protected in the wake-up acknowledgement and therefore hidden from being directly detected by the attackers. When the identifier(s) being protected can be more important for the transmission or there are more identifiers being protected, it is more difficult for the attackers to obtain the original identifiers. Therefore, the whole transmission is more robust.

A second aspect of the present invention provides a communication device (500), including a transmitter (501), a receiver (503) and a processor (505). An embodiment according to this aspect is complementary to an embodiment according to the first aspect, in particular embodiments of both aspects work together. The transmitter (501) is configured to transmit to a first device (400) a wake-up signal for waking up the first device (400). The receiver (503) is configured to receive from the first device (400) a wake-up acknowledgement indicating that the first device (400) is active, wherein the wake-up acknowledgement comprises a protected identifier (pID) of the first device (400). The processor (505) is configured to perform a de-protection on the pID to obtain an identifier (ID) of the first device (400).

The identifications in a wake-up acknowledgement is transmitted in a protection and should be de-protection, which makes it difficult for attackers to know an existence of the communication device 400 and the identifier(s) of the communication device 400. Therefore, vulnerability of the communication system to (battery-targeted) DoS attacks can be mitigated.

In a further implementation form of the second aspect of the present invention, the processor (505) is configured to perform the de-protection by descrambling and/or by decrypting the pID.

The descrambling or decryption of the pID can help safely read the ID from the received message, while the pID cannot be detected by attackers. Therefore, the robust of the transmission is enhanced.

In a further implementation form of the second aspect of the present invention, the de-protection is based on random information.

The random information ensures that the pID outputs are different on each run, which makes more difficult for attackers to detect the ID and therefore the robust of the transmission is further enhanced.

In a further implementation form of the second aspect of the present invention, the de-protection is a deconstruction of the pID based on the random information and a key.

The pID is achieved by deconstructing the pID according to the random information (used to randomize the ID by the first device) and the key (used to protect the ID by the first device). This can be easily accomplished by the processor and therefore the processing complexity of the communication device is limited.

In a further implementation form of the second aspect of the present invention, the receiver (503) is further configured to exchange the random information and/or the key with the first device (400).

Exchanging at least one of the random information and the key with the transmitting party of the wake-up acknowledgement can ensure a synchronization of information used by both communication parties of the wake-up acknowledgement. Therefore, the wake-up acknowledgement carrying the ID can be prepared by a correct transmitter and then safely parsed by a correct receiver. The whole process cannot by attacked by attackers.

In a further implementation form of the second aspect of the present invention, the random information is one of follows: an output of a cyclic counter, an output of a pseudorandom noise generator, and a payload of the wake-up acknowledgement.

Various options can be adopted by the processor to obtain the random information. This makes it easy for the processor to select one option according to practice requirement to deconstruct the pID. This enhances the robust of the whole transmission.

In a further implementation form of the second aspect of the present invention, the ID includes an association identifier of the communication device and/or a Media Access Control, MAC, source address of the first device.

One or more identifier can be protected in and then de-protected/obtained from the wake-up acknowledgement and therefore hidden from being directly detected by the attackers. When the identifier(s) being protected can be more important for the transmission or there are more identifiers being protected, it is more difficult for the attackers to obtain the original identifiers. Therefore, the whole transmission is more robust.

A third aspect of the present invention provides a communication method, including:
receiving (Step 602), by a communication device (400), from a second device (500) a wake-up signal for waking up the communication device (400);
turning (Step 603) the communication device (400) to active when the wake-up signal is received;
performing (Step 603), by the communication device (400), a protection on an identifier (ID) of the communication device to obtain a protected identifier (pID) of the communication device (400); and
transmitting (Step 604), by the communication device (400), to the second device (500) a wake-up acknowledgement indicating that the communication device (400) is active, wherein the wake-up acknowledgement comprises the pID.

A fourth aspect of the present invention provides a communication method, including:
transmitting (Step 602), by a communication device (500), to a first device (400) a wake-up signal for waking up the first device (400);
receiving (Step 604), by the communication device (500), from the first device (400) a wake-up acknowledgement indicating that the first device (400) is active, wherein the wake-up acknowledgement comprises a protected identifier (pID) of the first device (400);
performing (Step 605), by the communication device (500) a de-protection on the pID to obtain an identifier (ID) of the first device (400).

A fifth aspect of the present invention provides a computer program comprising a program code for performing, when running on a computer, the method according to the third or the fourth aspect of the present invention.

### BRIEF DESCRIPTION OF THE DRAWINGS

The above aspects and implementation forms of the present invention will be explained in the following description of specific embodiments in relation to the enclosed drawings, in which:

FIGS. 1 and 2 show a communication system with a WUR.

FIG. 3 shows a wake-up procedure for a power-saving device.

FIG. 4 shows a block diagram of a communication device according to an embodiment of the present invention.

FIG. 5 shows a block diagram of another communication device according to an embodiment of the present invention.

FIG. 6 shows a block diagram of a communication between a communication device shown as Fig.4 and another communication device shown as FIG. 5 according to an embodiment of the present invention.

FIG. 7 shows a process of an encryption and randomization according to an embodiment of the present invention.

FIG. 8 shows a process of an encryption and randomization according to another embodiment of the present invention.

FIG. 9 shows a process of an encryption and randomization according to another embodiment of the present invention.

### DETAILED DESCRIPTION OF THE EMBODIMENTS

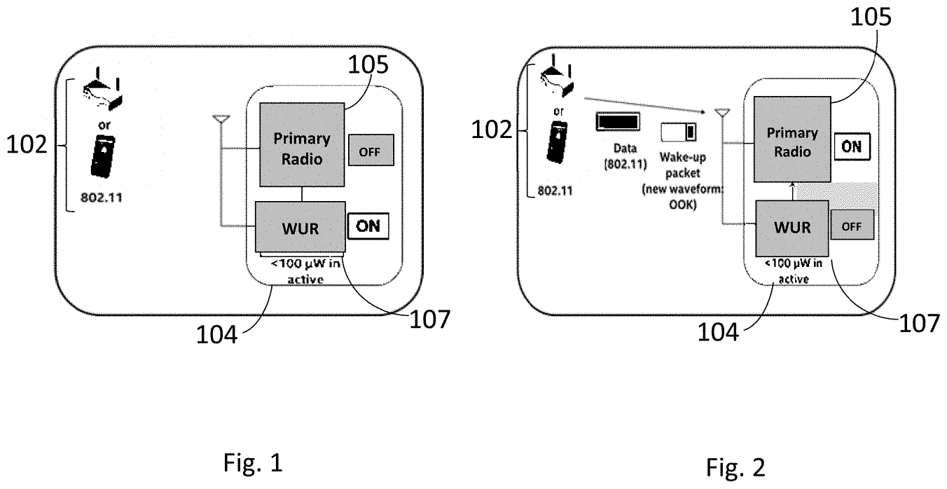

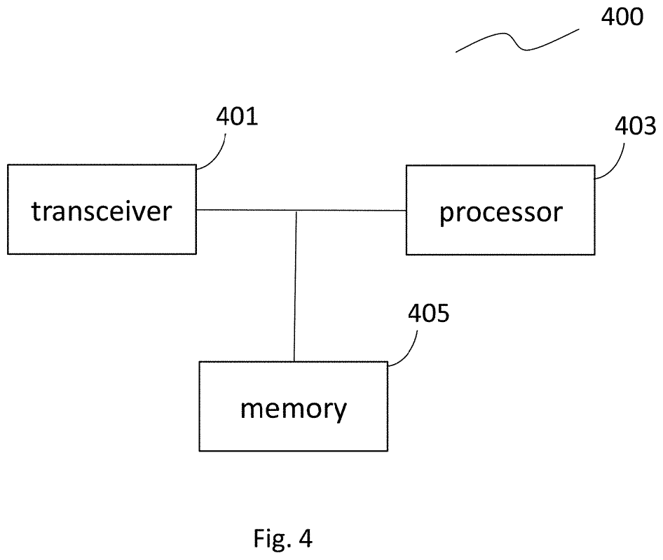

FIG. 4 shows a communication device 400 according to an embodiment of the present invention. The communication device 400 may be a power-saving device. For example, the communication device 400 is a IoT device such as a small size device or a mobile device with limited battery. The communication device 400 can based on 802.11 protocol communicate with other devices, for example, the AP 102 shown in FIG. 1 and FIG. 2.

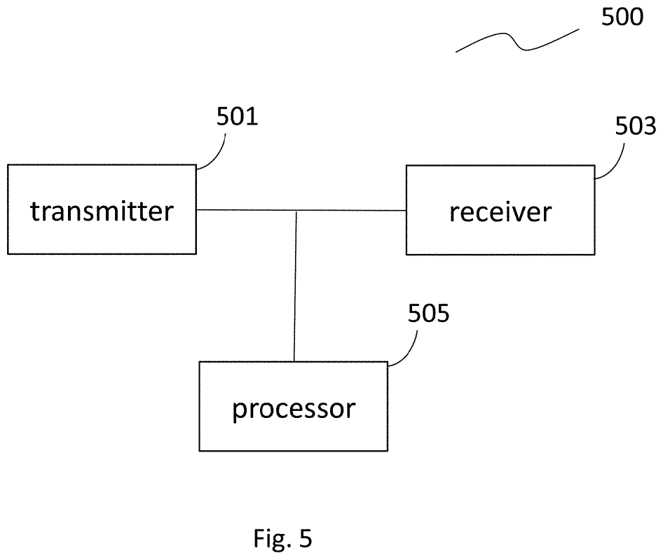

FIG. 5 shows a communication device 500 according to an embodiment of the present invention. The communication device 500 may be an access point (AP), e.g., for Wi-Fi communications. For example, the communication device 500 is a Wi-Fi AP such as a home gateway. The communication device 500 may be a device integrated with a function of providing Wi-Fi access, namely a soft-AP, in particular comprised by a mobile communication device. The communication device may be a WLAN device capable of working in an independent basic service set (IBSS) mode with other devices for example another WLAN IBSS device. In an example, the communication device 500 is a laptop communicating with another laptop using an Ad-hoc protocol. The communication device 500 can based on 802.11 protocol communicate with other devices, for example, small size devices with limited battery such as the mobile device 104 shown in FIG. 1 and FIG. 2.

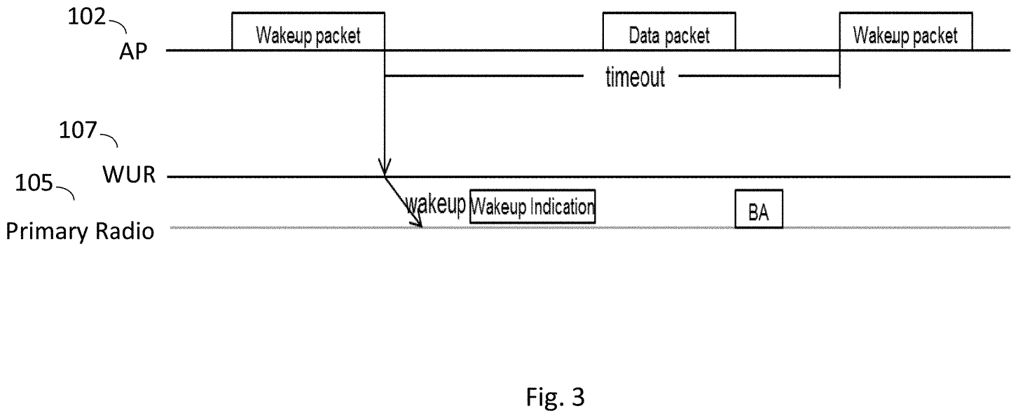

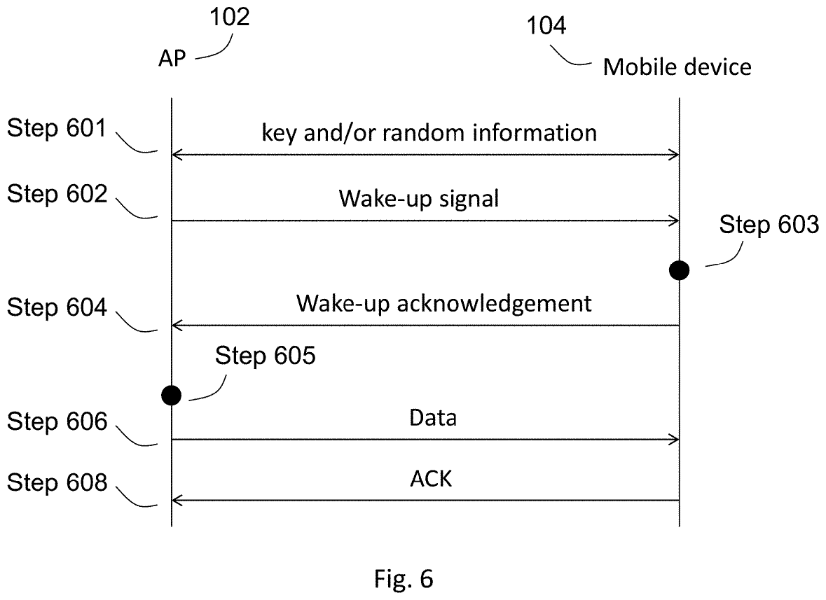

The communication device 400 as shown in FIG. 4 may communicate with the communication device 500 as shown in FIG. 5 in a communication system, for example as shown in FIG. 1 and FIG. 2. The communication may be any transmission of data or signal, in particular the transmissions as shown in FIG. 6, where the communication device 400 is used as the mobile device 104 and the communication device 500 is used as the AP 102. For example, the communication device 500 can decide to wake up the communication device 400 based on according to its internal scheduler, in particular before it wants to send a data packet to the communication device 400 as shown in FIG. 3 and/or FIG. 6. For another example, the communication device 500 decides to wake up the communication device 400 at a certain time or every time window based on a request to be woke-up sent by the communication device 400. The communication device then transmits a wake-up signal (also namely a wake-up packet or a wake-up frame) on a certain resources such as a predefined channel, where the wake-up signal includes a wake-up ID which lets the communication device 400 learn that the wake-up signal is dedicated to it. Upon receiving a wake-up acknowledgement (also namely a wake-up indication), the communication device 500 can transmit subsequent data to the communication device 400. The wake-up signal may be a signal standardized as part of the IEEE 802.11ba standard.

In an embodiment of the present invention, the communication device 400 enables to protect its identifier(s), for example its association identifier and its (MAC source) address, in a response to a wake-up signal of another device such as the communication device 500. For example, the identifier(s) can be scrambled and/or encrypted in a non-repetitive manner, in particular based on random information which can keep on changing, so that the protected identifier(s) in each response sent from the communication device 400 can be different from each other. The protection of identifications via scramble/encryption and randomization in a wake-up acknowledgement makes it difficult for attackers to know an existence of the communication device 400 and the identifier(s) from the response corresponding to the wake-up signal (e.g., the wake-up acknowledgement). Therefore, vulnerability of the communication system to (battery-targeted) DoS attacks can be mitigated.

As shown in FIG. 4, the communication device 400 may include a transceiver 401 and a processor 403. The transceiver 401 may be replaced with a transmitter and a receiver. The communication device 400 can perform steps of the mobile device 104 as shown in FIG. 6.

The transceiver 401 may be configured to receive (Step 602) from another device (e.g., the communication device 500) a wake-up signal for waking up the communication device 400.

The processor 403 may be configured to, when the wake-up signal is received by the transceiver 401, turn (in particular the communication device 400) to active and perform (Step 603) a protection on an identifier of the communication device 400 (namely ID hereinafter), to obtain a protected identifier of the communication device 400 (namely pID hereinafter). Technically, the communication device 400 is no longer sleeping when it turns to active and therefore it is ready to perform further communications with the communication device 500.

The transceiver 401 is further configured to transmit (Step 604) to the communication device 500 a wake-up acknowledgement indicating that the communication device (400) is active, wherein the wake-up acknowledgement comprises the pID.

Further, the transceiver 401 may be configured to receive (Step 606) data from the communication device 500 and subsequently transmit (Step 608) an acknowledgement of the data.

In an embodiment of the present invention, the communication device 500 enables to wake up another device such as the communication device 400 via a wake-up signal and read/recognize identifier(s) of the communication device 400 from a response corresponding to the wake-up signal. For example, in a scenario where the identifier(s) is scrambled and/or encrypted in a non-repetitive manner, the communication device 500 can de-protect the protected identifier(s) by descrambling and/or decrypting the protected identifier(s). The de-protection may be performed based on parameters, for example random information, which can be the same as those used by the communication 400 to generate the protected identifier(s). The de-protection may be a deconstruction of the pID based on the random information and a key. The parameters may be obtained by the communication device 500 in a safe way, which is difficult for attackers to know or masquerade. Therefore, vulnerability of the communication system to DoS attacks can be mitigated.

As shown in FIG. 5, the communication device 500 may include a transmitter 501, a receiver 503 and a processor 505. The transmitter 501 and the receiver 503 may be integrated for example as a transceiver. The communication device 500 can perform steps of the AP 102 as shown in FIG. 6.

The transmitter 501 may be configured to wake up another device (e.g., the communication device 400) by transmitting (Step 602) a wake-up signal.

The receiver 503 may be configured to receive (Step 604) from the communication device 400 a wake-up acknowledgement indicating that the communication device 400 is active. The wake-up acknowledgement includes a protected identifier of the communication device 400, namely pID.

The processor 505 may be configured to perform (Step 605) a de-protection on the pID to obtain an identifier of the communication device 400, namely ID.

Further, the transmitter 501 may be configured to transmit (Step 606) data with the communication device 400 and subsequently receive (Step 608) an acknowledgement of the data.

As shown in FIG. 6, the key and/or the random information may be exchanged (Step 601) between the mobile device 104 (i.e., the communication device 400) and the AP 102 (i.e., the communication device 500), for example during an association process or data transfer phase.

Information, such as the random information and/or the key, may be exchanged in a same manner or in different manners. Examples of exchanging manners adopted in Step 601 are as follows.

In a first exchanging manner, a 2-way handshake process including two new messages is used to exchange the information. For example, one communication device sends the first message carrying the random information to the other communication device. The other communication device may respond the first message with a second message carrying the same random information, or respond a receiving acknowledgement. Here, the term “carry” may refer to an occupation of the information in a payload of the message, or refer to a process (e.g., encryption) on the message based on the information.

By adopting the first exchanging manner, information can be updated or modified through new messages at any time when there is a requirement of exchanging the information. For example, after an association process (and/or 4 way handshake process) or during an existing process, which can be the same as the state of the art, the first message and the second message are transmitted to exchange the information. The exchanging of the information ensures accurate information be timely learned by both communication devices.

In a second exchanging manner, a 4-way handshake process is used to exchange the information. For example, a message 3 and a message 4 in the 4-way handshake process carry the information such as the random information and/or the key. Here, the term “carry” may refer to an occupation of the information in a payload of the message, or refer to a process (e.g., encryption) on the message based on the information.

By adopting the second exchanging manner, information can be exchanged through two messages which are modified based on existing messages of the normal 4-way handshake process in the state of the art. Other existing processes, (e.g., the association process) may not be used to exchange all or any information such as the random information and the key.

Examples of the key and the random information are as follows.

The key may be information used by the mobile device 104 to protect the ID in a scrambling or encryption process and by the AP 102 to de-protect the pID in a descrambling or encryption process. If the mobile device 104 and the AP 102 are pre-configured with information on how to generate or select the key in order to prevent any detection by attackers, it is not necessary to exchange the key in Step 601.

The random information may be an output of a cyclic counter, an output of a pseudorandom noise generator or a payload (namely available bytes) of the wake-up acknowledgement to ensure that the pID outputs are different on each run. Alternatively, the random information may be an index of a randomization method leading to a certain random value to be used by both communication devices in the communication.

As shown in FIG. 4, the processor 403 of the communication device 400 may be further configured to generate a randomized identifier of the communication device 400 (namely rID hereinafter) based on the ID and the random information, and to perform the protection based on a key and the rID in Step 603. Due to the protection of the ID and the random information, the communication device 400 answers wake-up signals (even sent from the same communication device 500) with various wake-up acknowledgements. The acknowledgements are different from each other by carrying different pID, in particular, different protected associated identifier of the communication device 400 and/or different protected MAC source address of the communication device 400.

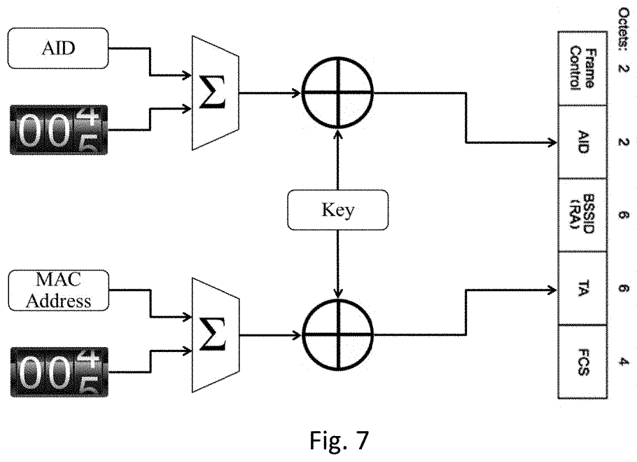

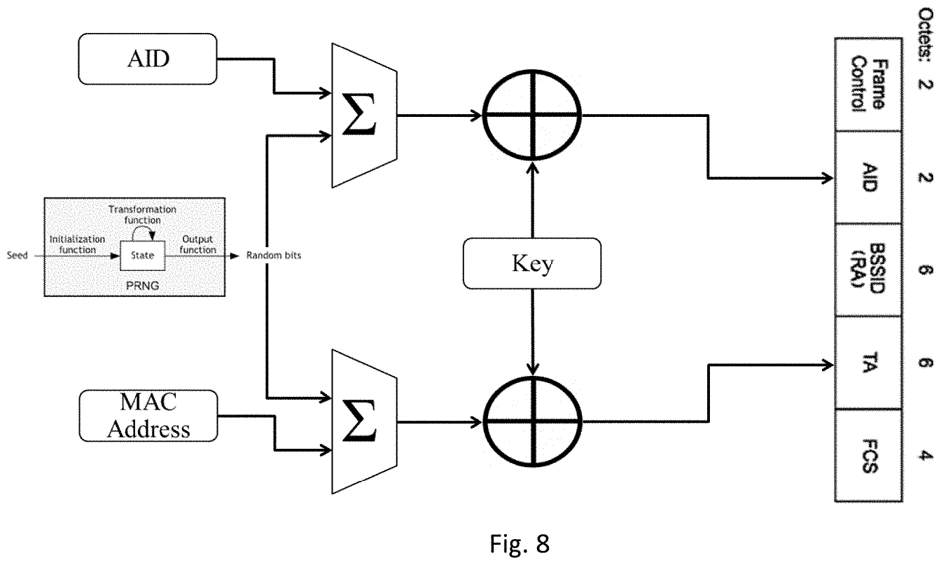

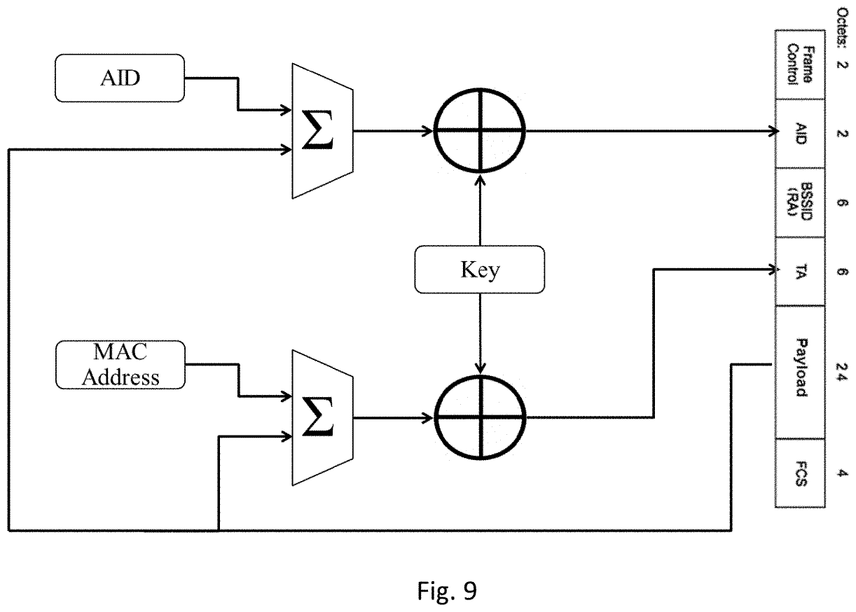

Correspondingly, as shown in FIG. 5, the processor 505 of the communication device 500 may be further configured to perform the de-protection based on the random information and the key in Step 605. Technically, the communication device performs a function which is opposite to a function (for example the sum function as shown in FIG. 7, FIG. 8 and/or FIG. 9) performed by the transmitter, for example the communication device 400, so that the communication device 500 can further subtract the random information from the result of descrambling and/or decrypting the pID and obtain the ID of the communication device 400.

The protection of the ID can be performed in different ways, for example as shown in FIG. 7, FIG. 8 and FIG. 9. The encryption of the ID is realized based on a key. The randomization of the ID is realized via different ways.

FIG. 7 shows a process of an encryption and randomization according to an embodiment of the present invention. The randomization of the ID is realized via a cyclic counter. The pID output is carried in a PS-Poll header. For example, the counter value is summed once with the associated identifier (namely AID) of the communication device 400 and once with the transmitter address (namely TA) of the communication device 400 so that a randomization effect is achieved. Each summed output is encrypted (e.g. XORed) with the key so that pID outputs to be carried in the header of a packet (e.g., the PS-Poll) are obtained. That is, instead of the original AID, a result of encryption and randomization of the AID occupies the AID field. Similarly, instead of the original TA, a result of encryption and randomization of the TA (e.g., MAC address) occupies the TA field. Besides the AID field and the TA field, the PS-Poll header can include a frame control field, a basic service set identifier (BSSID) field and a frame checking sequence (FCS) field.

FIG. 8 shows another process of an encryption and randomization according to an embodiment of the present invention. The difference between the processes shown as FIG. 8 and FIG. 7 is as follows. In FIG. 8, the randomization of the ID is realized via a pseudorandom noise generator (PRNG), whose output can be considered as a random token. That is, the PRNG process takes a seed as an input. An initialization function, a possible transformation function and an output function can be performed subsequently. The “state” shown in FIG. 8 changes every time the PREG runs, which ensures that different running provides different output. If the state is the same, the same output is produced. Then the PRNG process provides random bit(s) as an input to the randomization of the ID. The random bit(s) can be summed with the ID so that the ID is randomized.

FIG. 9 shows another process of an encryption and randomization according to an embodiment of the present invention. The difference between the processes shown as FIG. 9 and FIG. 7 is as follows. In FIG. 9, the randomization of the ID is realized via a payload of the PS-Poll. That is, the available bytes can be completely or partially selected as an input to the randomization of the ID. The selected byte(s) can be summed with the ID so that the ID is randomized.

The invention has been described in conjunction with embodiments including communication devices such as a mobile device and an access point. However, other applications can be understood and effected by those skilled in the art in practicing the claimed invention, from a study of the drawings, the disclosure, and the appended claims.

The elements described as separate parts in the communication device 400 or the communication device 500 may or may not be physically separate in order to further improve efficiency, processing complexity, or performance of the device or a system including the device.

A computer program may be stored or distributed on a suitable medium, such as an optical storage medium or a solid-state medium supplied together with or as part of other hardware, but may also be distributed in other forms, such as via the Internet or other wired or wireless telecommunication systems.

What is claimed is:

1. A communication device (400), comprising a transceiver (401) and a processor (403), wherein:
the transceiver (401) is configured to receive from a second device (500) a wake-up signal for waking up the communication device (400);
the processor (403) is configured to turn to active when the wake-up signal is received by the transceiver (401) and to perform a protection on an identifier (ID) of the communication device to obtain a protected identifier (pID) of the communication device; and
the transceiver (401) is further configured to transmit to the second device (500) a wake-up acknowledgement indicating that the communication device (400) is active, wherein the wake-up acknowledgement comprises the pID.

2. The communication device (400) according to claim 1, wherein
the processor (403) is configured to perform the protection by scrambling and/or by encrypting the ID.

3. The communication device (400) according to claim 1, wherein the protection is based on random information.

4. The communication device (400) according to claim 3, wherein the processor (403) is configured to generate a randomized identifier (rID) of the communication device (400) based on the ID and the random information, and to perform the protection based on a key and the rID.

5. The communication device (400) according to claim 3, wherein the random information is one of follows:
an output of a cyclic counter,
an output of a pseudorandom noise generator, and
a payload of the wake-up acknowledgement.

6. The communication device (400) according to claim 3, wherein
the transceiver (401) is further configured to exchange the random information and/or the key with the second device (500).

7. The communication device (400) according to claim 4, wherein the ID includes an association identifier of the communication device and/or a Media Access Control, MAC, source address of the communication device.

8. A communication device (500), comprising a transmitter (501), a receiver (503) and a processor (505), wherein:
the transmitter (501) is configured to transmit to a first device (400) a wake-up signal for waking up the first device (400);
the receiver (503) is configured to receive from the first device (400) a wake-up acknowledgement indicating that the first device (400) is active, wherein the wake-up acknowledgement comprises a protected identifier (pID) of the first device (400);
the processor (505) is configured to perform a de-protection on the pID to obtain an identifier (ID) of the first device (400).

9. The communication device (500) according to claim 8, wherein
the processor (505) is configured to perform the de-protection by descrambling and/or by decrypting the pID.

10. The communication device (500) according to claim 8, wherein the de-protection is based on random information.

11. The communication device (500) according to claim 10, wherein the de-protection is a deconstruction of the pID based on the random information and a key.

12. The communication device (500) according to claim 10, wherein
the receiver (503) is further configured to exchange the random information and/or the key with the first device (400).

13. The communication device (500) according to claim 10, wherein the random information is one of follows:
an output of a cyclic counter,
an output of a pseudorandom noise generator, and
a payload of the wake-up acknowledgement.

14. The communication device (500) according to claim 8, wherein the ID includes an association identifier of the communication device and/or a Media Access Control, MAC, source address of the first device.

15. A communication method, comprising:
receiving (Step 602), by a communication device (400), from a second device (500) a wake-up signal for waking up the communication device (400);
turning (Step 603) the communication device (400) to active when the wake-up signal is received;
performing (Step 603), by the communication device (400), a protection on an identifier (ID) of the communication device to obtain a protected identifier (pID) of the communication device (400); and
transmitting (Step 604), by the communication device (400), to the second device (500) a wake-up acknowledgement indicating that the communication device (400) is active, wherein the wake-up acknowledgement comprises the pID.

16. A communication method, comprising:
transmitting (Step 602), by a communication device (500), to a first device (400) a wake-up signal for waking up the first device (400);
receiving (Step 604), by the communication device (500), from the first device (400) a wake-up acknowledgement indicating that the first device (400) is active, wherein the wake-up acknowledgement comprises a protected identifier (pID) of the first device (400);
performing (Step 605), by the communication device (500) a de-protection on the pID to obtain an identifier (ID) of the first device (400).

17. A computer program comprising a computer code for performing the method according to claim 15 when the computer program runs on a computer.

18. A computer program comprising a computer code for performing the method according to claim 16 when the computer program runs on a computer
